(19) United States
(12) Patent Application Publication
(10) Pub. No.: US 2005/0195475 A1
(43) Pub. Date: Sep. 8, 2005

(54) Microscope

(75) Inventor: Hideki Obuchi, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Corporation, Tokyo (JP)

(21) Appl. No.: 11/048,090

(22) Filed: Feb. 1, 2005

(30) Foreign Application Priority Data
Feb. 3, 2004 (JP) 2004-026776

(51) Int. Cl. G02B 21/00

(52) U.S. Cl. 359/383; 359/368

(57) ABSTRACT

A microscope has a microscope body, a stage which is provided at the microscope body, and on which a sample is placed, focusing handles which are provided at both sides of the microscope body to move the stage in upwardly and downwardly, an optical system which performs an image formation of an optical image of the sample, and a plurality of switches which are provided at a lower part of the microscope body, in which at least two switches which are adjacent with each other are provided at a front surface of the microscope body, and two switches thereof are inclined with respect to a rotation axis of the focusing handle.

### BACKGROUND OF THE INVENTION

1. Field of the Invention

The present invention relates to a microscope which is provided with a switch which operates a driving portion.

Priority is claimed on Japanese Patent Application No. 2004-026776, filed Feb. 3, 2004, the content of which is incorporated herein by reference.

2. Description of Related Art

A stage for a microscope for observing a semiconductor wafer must be made larger as the size of semiconductor wafers increases.

In the case of such a microscope, an operation portion for moving the stage in a horizontal direction and an operation portion for operating a focusing handle are arranged at a front side as much as possible, and thereby operation performance is improved. Moreover, portions which are frequently operated, such as apportion for changing a magnification of an objective lens, often employ electric switching using switches.

As examples of arrangements of the focusing handle and switches of an electric switching portion, when hands are put on the focusing handle from a perpendicular direction with respect to the axial direction so that a first finger is put on an outer circumference of the focusing handle, a first switch is arranged in a natural operating locus of a thumb, and a second switch, a third switch, and a fourth switch are arranged in natural operating loci of a middle finger, ring finger, and a little finger, respectively (Patent Document 1: Japanese Unexamined Utility Model Application, First Publication No. H1-157308). In such an arrangement, the hands does not have to be moved from the focusing handle, when pushing the four switches.

There is a conventional technology, in which a pair of revolver transfer switches for changing a rotating direction of a electric revolver between clockwise and counterclockwise directions, is provided at both side surfaces of a microscope body and near the focusing handles (for example, Patent Document 2: Japanese Unexamined Patent Application, First Publication No. H10-333017). A revolver transfer switch at a right side surface is composed of a push button for rotating the electric revolver in a counterclockwise direction, and another push button for rotating the electric revolver in a clockwise direction. Furthermore, a revolver transfer switch at a left side surface is arranged in the similar manner to the revolver transfer switch at the right side surface.

### SUMMARY OF THE INVENTION

An object of the present invention is to provide a microscope in which an operation performance of an electric change switch can be improved.

The present invention solves the above-mentioned problem by providing a microscope having a microscope body, a stage which is provided at the microscope body, and on which a sample is placed, focusing handles which are provided at both sides of the microscope body to move the stage in upward and downward, an optical system which performs an image formation of an optical image of the sample, a plurality of switches which are provided at a lower part of the microscope body, in which at least two switches which are adjacent to each other are provided at a front surface of the microscope body, and the two switches are inclined with respect to a rotation axis of a focusing handle.

In the present invention, the switches may be arranged on a circular arc.

In the present invention, a driving portion may be provided, the driving portion is a revolver for objective lenses, and the revolver for the objective lenses may be rotated in clockwise and counterclockwise directions by the switches.

In the present invention, in the case of being seen from the front surface of the microscope body, the switch which rotates the revolver toward a right direction may be arranged at a right side of the switch which rotates the revolver toward a left direction.

In the present invention, the switch which rotates the revolver to increase a magnification of the objective lens may be arranged at an upper side of the switch which rotates the revolver to reduce the magnification of the objective lens.

In the present invention, the switches may be arranged at a right side and at a left side of the front surface of the microscope body, respectively.

In the present invention, the switch which rotates the revolver may be arranged at the front surface of one focusing handle side, and a plurality of switches which control a light diaphragm which illuminates the sample may be arranged at the front surface of another focusing handle side.

In the present invention, a fixing member may be provided, in which the fixing member is attached to a supporting member which is rotatable, and fixes the supporting member at an unprescribed angle.

The present invention is a microscope having a microscope body, a stage which is provided at the microscope body, and on which a sample is placed, focusing handles which are provided at both sides of the microscope body to move the stage in upward and downward, an optical system which performs an image formation of an optical image of the sample, a plurality of switches which are provided at a lower part of the microscope body, in which at least two contacts of the switches which are adjacent to each other are provided at a front surface of the microscope body, and the two contacts are inclined with respect to a rotation axis of the focusing handle.

### BRIEF DESCRIPTION OF THE DRAWINGS

FIG. 1 is an overall construction view of a microscope according to an embodiment of the present invention.

FIG. 2 is a view seen from arrow “Y” in FIG. 1, and is a view which shows an arrangement and an operation of a switch which is arranged at a front surface.

FIG. 3 is a view which shows a movement when the switch is pushed.

FIG. 4 is a view which shows a movement when the switch is pushed.

FIG. 5 is a view which shows a posture of an observer when observing the microscope.

FIG. 6 is a view which explains an operation of the switch.

FIG. 7 is a view which shows a movement when the switch is pushed.

FIG. 8 is a view seen from arrow “Y” in FIG. 1, and is a view which shows an arrangement and an operation of switch which is arranged at a front surface.

FIG. 9 is a view which shows arrangements of a brightness diaphragm.

FIG. 10 is a view which explains a movement of the diaphragm when the switch is pushed.

FIG. 11 is a view which explains the operation of the switch.

FIG. 12 is a view which explains a movement of the diaphragm when the switch is pushed.

FIG. 13 is a view seen from arrow “Y” in FIG. 1, and is a view which shows an arrangement and an operation of the switch which is arranged at a front surface.

FIG. 14 is a cross-sectional view which shows an arrangement construction of the switch.

FIG. 15 is a view which shows the arrangement construction of the switch.

FIG. 16 is a view seen from arrow “Y” in FIG. 1, and is a view which shows an arrangement and an operation of the switch which is arranged at a front surface.

### DETAILED DESCRIPTION OF THE INVENTION

Next, a preferable embodiment of the present invention is explained with reference to the figures.

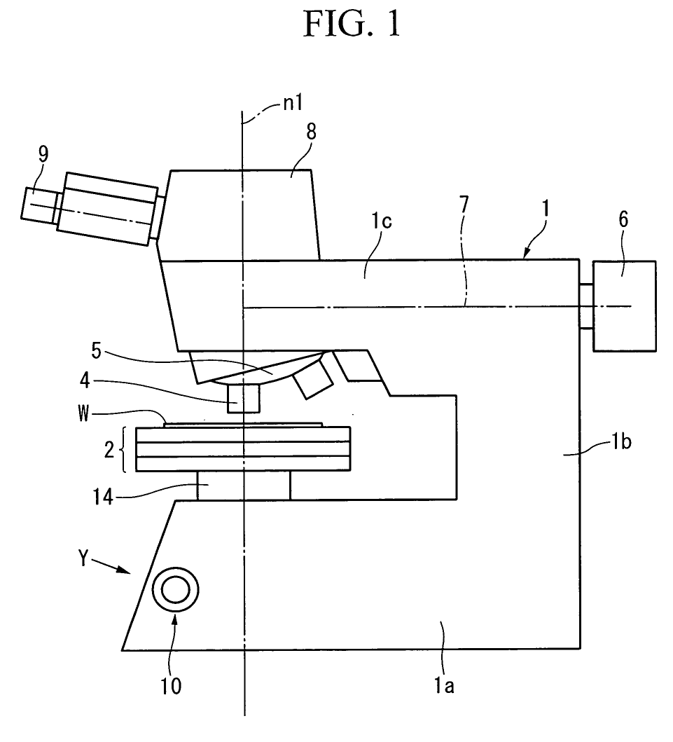

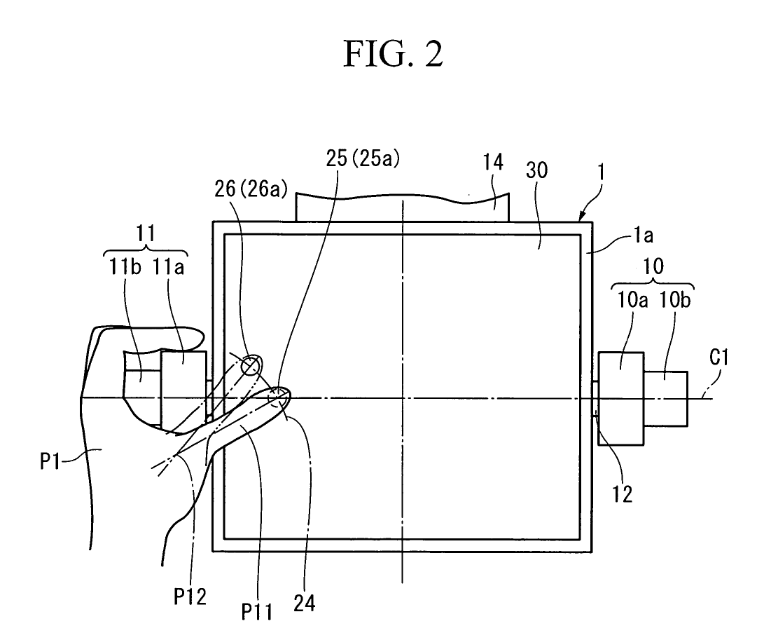

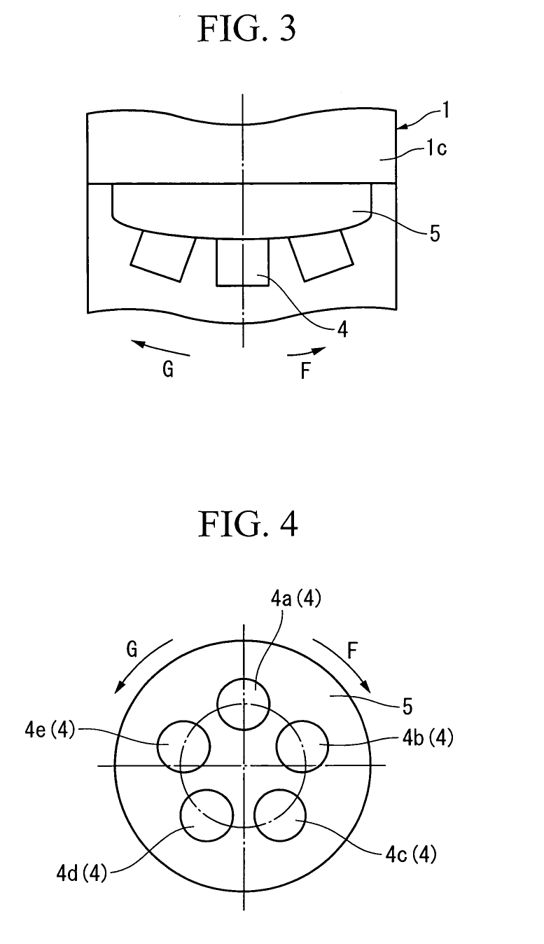

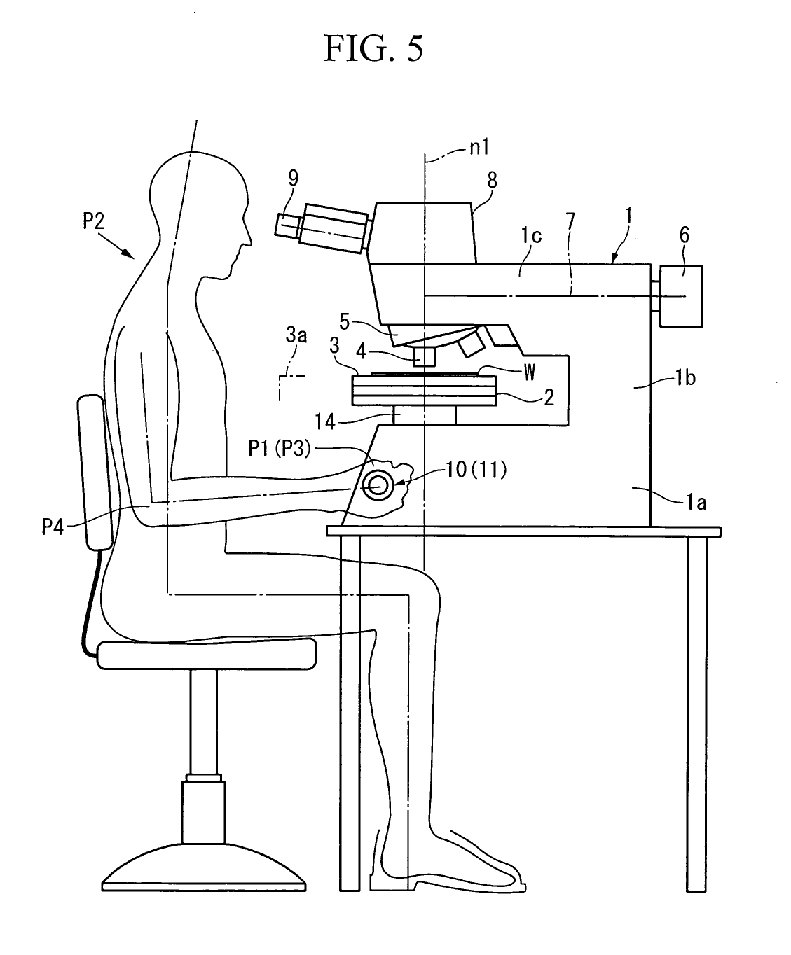

FIG. 1 is an overall construction view of a microscope according to a first embodiment, and FIG. 2 is a view seen from arrow “Y” in FIG. 1, and shows an arrangement and an operation of a switch which is arranged at a front surface. FIG. 3 and FIG. 4 are views which explain the movement of the revolver when the switch is pushed. FIG. 5 shows a posture of an observer when observing the microscope.

As shown in FIG. 1, the microscope is provided with a microscope body 1. The microscope body 1 is composed of a base portion 1a which has a focusing portion on which a stage is disposed, a standing portion 1b which stands from a rear portion of the base portion 1a, and an arm portion 1c which extends above the base portion 1a from an upper portion of the standing portion 1b.

As shown in FIG. 2, focusing handles 10 and 11 are supported by both ends of the base portion 1a, and rotate about an axis 12. The focusing handles 10 and 11 are composed of a coarse movement handle 10a and 11a, and a fine movement handle 10b and 11b, respectively. The axis 12 of the focusing handles 10 and 11 is connected to a focusing holder 14 via, for example, a transmission mechanism (not shown in figures) such as a pinion and a rack, or the like.

As shown in FIG. 1, the focusing holder 14 is arranged at a rear and upper part of the focusing handles 10 and 11. The stage 2 on which a sample W is placed is attached on the focusing holder 14. The transmission mechanism and the focusing holder 14 constitute a transportation apparatus which moves the stage 2 in upward and downward with respect to the microscope body 1.

The revolver 5 at which a plurality of objective lenses 4 can be equipped is rotatably attached to the arm portion 1c of the microscope body 1 above the stage 2. An incident-light illumination optical system (not shown in figures) is arranged along an illumination optical axis 7 in the arm portion 1c, and a lamp house 6 including a light source is attached to the microscope body 1 corresponding to a position of the illumination optical axis 7. Furthermore, a mirror case 8 is detachably attached to an upper part of the arm portion 1c along an optical axis n1 which connects predetermined objective lenses 4 and the sample W. An eyepiece for observing an image of a sample W is attached to the mirror case 8.

Moreover, as shown in FIG. 2, push-type switches 25 and 26 are provided at a front surface 30 of the base portion 1a of the microscope body 1. The switches 25 and 26 are arranged at positions at which the switches 25 and 26 can be pushed by the thumb P11, when the focusing handle 11 is covered with the left hand P1 from an outside (side part) in an axis direction. Especially, when a fingertip of the thumb P11 moves at a center of a CM joint (root joint) P12 of the thumb P11 of the left hand P1, the switches 25 and 26 may be arranged on an operating locus 24 of a circular arc shape. For example, the switch 25 is arranged on a line at which a plane surface which passes through a rotation axis C1 of the focusing handle 11 and the front surface 30 intersect with each other. The switch 26 is arranged at a left side of the switch 25 (at a focusing handle 11 side) and at an upper position of the switch 25. That is, a straight line which passes through the switch 25 and the switch 26 has a falling gradient from a right end portion toward a center portion in the front surface 30, and are inclined with respect to a horizontal surface which passes through the rotation axis C1 of the focusing handle 10 and 11. In addition, the CM joint P12 is the third joint from a front end of the thumb P11, that is, is the nearest joint to a wrist in the thumb P11.

The switches 25 and 26 which are arranged as described above have contacts 25a and 26a which have approximate identical shapes to the external shapes of the switches 25 and 26, respectively. Each contact 25a and 26a is electrically connected to an electric circuit (not shown in the figures) which rotates and drives the revolver 5, the contact 25a of the switch 25 which is arranged at the right side is connected to the electric circuit in order to rotate the revolver 5 in a right direction seen from the front surface and clockwise as seen from the lower part, which is shown by arrow F in FIG. 3 and FIG. 4. The contact 26a of the switch 26 which is arranged at a left side is connected to the electric circuit in order to rotate the revolver 5 in a left direction seen from the front surface and counterclockwise as seen from the lower part, which is shown by arrow G in FIG. 3 and FIG. 4.

Here, the objective lenses 4 (the objective lenses 4a to 4e) are attached to the revolver 5 so that the magnification becomes high in the clockwise direction seen from the lower part. Therefore, the switch 26 arranged at the upper side increases the magnification of the objective lenses 4, and the switch 25 arranged at the lower side reduces the magnification of the objective lenses 4. In addition, in FIG. 4, the objective lens 4a is arranged on an optical axis n1 (with reference to FIG. 1).

Procedure in the case of observing the sample W by the microscope is explained with reference to FIG. 5, mainly.

First, the sample W is placed on the stage 2. Furthermore, the light which is emitted by the light source in the lamp house 6 goes through the incident-light illumination system along the illumination optical axis 7, and illuminates the sample W via one of the objective lenses 4. The light reflected by the sample W passes through one of the objective lenses 4 again, is led to the eyepiece 9 via the mirror case 8, and is observed by the observer P2.

Hands P1 and P3 of the observer P2 are put on the left and right focusing handles 10 and 11, surrounding the left and right focusing handles 10 and 11 from the side part. Furthermore, as shown in FIG. 2, the thumb P11 of the left hand P1 is put on either the switch 25 or 26 of the front surface 30. In addition, because the focusing handles 10 and 11 are arranged at the lower and front part of the stage 2, when the observer P2 performs the focusing operation, even if the stage 2 moves to a front side stroke position 3a which projects most toward the observer P2, the focusing handles 10 and 11 do not touch to the observer P2. Furthermore, the focusing handles 10 and 11 can be operated on the condition that an elbow P4 is bent at an unstrained angle (about 90 degrees). In addition, the movement of the sample W in a horizontal direction is performed by a handle (not shown in the figures) which is provided at the stage 2.

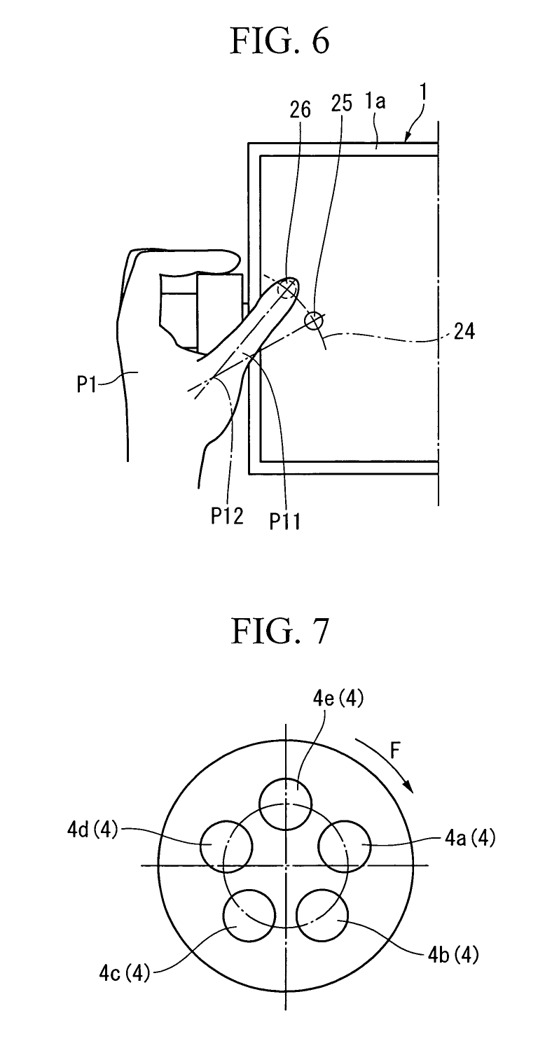

As shown in FIG. 6, when the image of the sample W is observed at high magnification, the thumb P11 of the left hand P1 is rotated at a center of the CM joint P12, and the switch 26 which is arranged at the upper left position, out of two switches 25 and 26, is pushed. A signal from the switch 26 is sent to an electric circuit (not shown in figures), and the electric circuit allows the revolver 5 to rotate in a left direction (a direction of arrow G in FIG. 3 and FIG. 4) seen from the observer P2. Thereby, for example, as shown in FIG. 4, as one of the objective lenses 4 which is arranged on the optical axis n1, a switching from the objective lens 4a to the high magnification of objective lens 4b is performed.

Moreover, as shown in FIG. 2, when the image of the sample W is observed at low magnification, the thumb P11 of the left hand P1 is rotated at a center of the CM joint P12, and the switch 25 which is arranged at the lower right position is pushed. Based on a signal from the switch 25, the electric circuit allows the revolver 5 to rotate in a right direction (a direction of arrow F in FIG. 3) seen from the observer P2. Thereby, for example, as shown in FIG. 7, as one of the objective lenses 4 which is arranged on the optical axis nil, a switching from the objective lens 4e to the low magnification of objective lens 4d is performed.

Furthermore, when the switch 25 and the switch 26 are pushed by turns, the fingertip of the thumb P11 is moved at the center of the CM joint P12 along the operation locus 24. Thereby, regarding the revolver 5, the objective lenses 4 are rotated according to the number of pushes of the switch 25 or 26, or to the length of time of pushing of the switch 25 or 26, and thereby the objective lenses 4 are switched. In addition, as an exception of the above case, when the objective lenses 4 are switched from the highest magnification of the objective lens 4e to the minimum magnification of the objective lens 4a, even if the switch 26 which is arranged at the high side is pushed, the magnification of the objective lenses 4 becomes low.

According to the present embodiment, the switching of the objective lenses 4 can be performed without almost moving the hands from the focusing handles 10 and 11 which are used for focusing. Furthermore, because the switches 25 and 26 are arranged at the front surface 30 near one of the focusing handles (focusing handle 11) according to the movement of the joint of the thumb P1, an operation can be smoothly performed, and a natural finger operation can be performed.

Furthermore, the movement of the objective lenses 4, that is, a rotating direction of the revolver 5 corresponds to the arrangement in the width (left and right) direction of the switches 25 and 26, while high and low of the objective lenses correspond to the arrangement in the longitudinal (upper and lower) direction of the switches 25 and 26 (high magnification is high, and low magnification is low). Therefore, because the observer P2 can understand the operation easily, an operation performance is good, and thereby operation errors can be avoided.

Next, the second embodiment of the present invention is explained with reference to the figures.

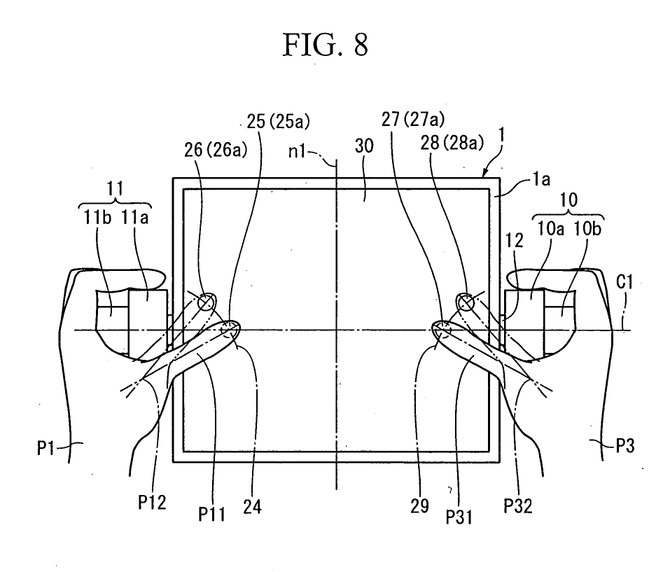

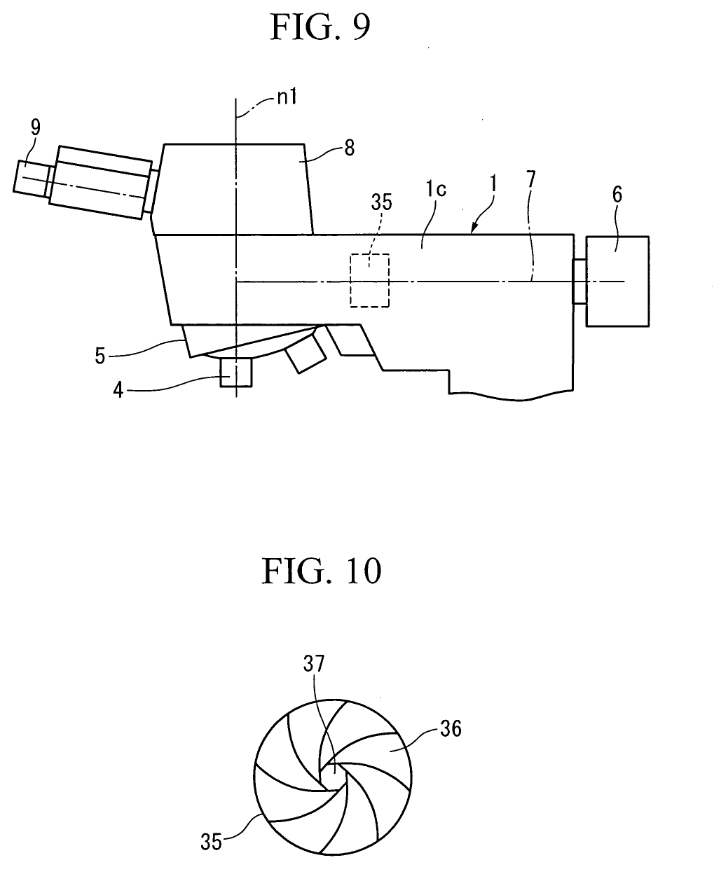

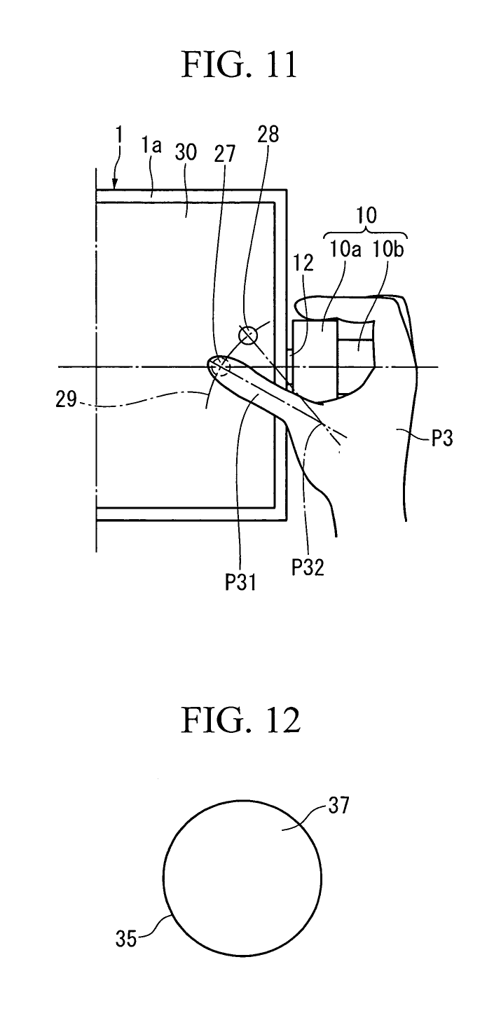

FIG. 8 is a view which shows an arrangement and an operation of the switch of the front surface in the second embodiment. FIG. 9 shows the arrangements of a brightness diaphragm. FIG. 10 and FIG. 12 are views which explain movement of the diaphragm when the switch is pushed. FIG. 11 is a view which explains the operation.

In addition, the same symbols are attached to the same constructions as the first embodiment. Moreover, the explanation which duplicates with the explanation of the first embodiment is omitted.

As shown in FIG. 8, at the front surface 30 of the microscope body 1 in the present embodiment, the push-type switches 27 and 28 are arranged at the opposite side with the switches 25 and 26, and at portions adjacent to the focusing handle 10 at the right side.

When the focusing handle 10 is covered by the right hand P3 from the outside (side part) in the axis direction at the right side of the front surface 30, the switches 27 and 28 are arranged at a position at which the switches 27 and 28 can be pushed by the thumb P31 of the right hand P3. In particular, when a fingertip of the thumb P31 moves at a center of CM joint (root joint) P32 of the thumb P31 of the right hand P3, the switches 27 and 28 are arranged on an operating locus 29 of circular arc shape. The switch 27 is arranged on a line at which a plane surface which passes through a rotation axis C1 of the axis 12 of the focusing handle 10 and the front surface 30 intersect with each other. The switch 28 is arranged at a right side of the switch 27 (at a focusing handle 10 side) and at a position above the switch 27. That is, a straight line which passes through the switch 25 and the switch 26 has a falling gradient from a right end portion toward a center portion in the front surface 30, and is inclined with respect to a horizontal surface which passes through the rotation axis C1 of the focusing handles 10 and 11.

The switches 27 and 28 which are arranged as described above have contacts 27a and 28a which have approximate identical shapes to those of the switches 27 and 28, respectively. Each of the contacts 27a and 28a is connected to the electric circuit which controls the diaphragm 35 of the brightness of the incident-light illumination system as shown in FIG. 9. For example, as shown in FIG. 10, the diaphragm 35 is composed of a plurality of diaphragm blades 36, and changes a size of an aperture 37 by the diaphragm blades 36. The contact 27a of the switch 27 is connected to the electric circuit so that the contact 27a closes the aperture 37 of the diaphragm 35, and the contact 28a of the switch 28 is connected to the electric circuit so that the contact 28a opens the aperture 37 of the diaphragm 35. That is, the switch 28 situated at the upper position has a high (large) aperture degree of the diaphragm 35, and the switch 27 situated at a lower position has a low (small) aperture degree of the diaphragm 35.

When the diaphragm 35 is opened, as shown in FIG. 11, the thumb P31 of the right hand P3 is rotated at a center of the CM joint P32, and the switch 28 which is arranged at the right and upper side among two switches 27 and 28 is pushed. A signal from the switch 28 is transmitted to the electric circuit, and the diaphragm 35 is opened. Thereby, for example, the diaphragm 35 can be opened to a maximum aperture degree, as shown in FIG. 12. Furthermore, according to the size of the aperture 37 of the diaphragm 35, a quantity of light which is emitted from the lamp housing 6 to the sample W increases, and thereby a field of view which is observed with the eyepiece 9 becomes bright.

Furthermore, as shown in FIG. 8, when the diaphragm 35 is closed, the thumb P31 of the right hand P3 is rotated at the center of the CM joint P32, the switch 27 which is arranged at the lower left position, out of the two switches 27 and 28, is pushed, the aperture degree of the diaphragm 35 decreases, and thereby the field of view which is observed with the eyepiece 9 becomes dark.

Furthermore, when the switch 27 and the switch 28 are pushed alternately, the thumb P31 is rotated along the operation locus 29 of the CM joint P32 of the thumb P31.

According to the present embodiment, in addition to the first embodiment, by pushing the switch 28 which is arranged at the side of the other focusing handle (focusing handle 10) on the front surface 30, the diaphragm 35 of the brightness electrically becomes large in the opening direction. On the other hand, when the switch 27 is pushed, the diaphragm 35 of the brightness electrically becomes small in the closing direction. Therefore, by the number of times which the switches 27 and 28 are pushed, or the length of time which the switches 27 and 28 are pushed, the aperture of the diaphragm 35 can be changed in a range from a minimal diameter to a maximal diameter.

Moreover, because the movement of the diaphragm 35 of the brightness corresponds to the arrangement in the longitudinal direction of the switches 27 and 28 (the aperture degree is large at the upper portion, and the aperture degree is small at the lower portion), the observer P2 can understand easily how to operate them, an operation performance is good, and thereby operation errors can be avoided.

In addition, instead of the diaphragm 35 of the brightness, the switches 27 and 28 may be connected to the electric circuit which controls the diaphragm of the field of view. The size of the field of view can be controlled by the operation at hand.

Next, the third embodiment of the present invention is explained with reference to the figures.

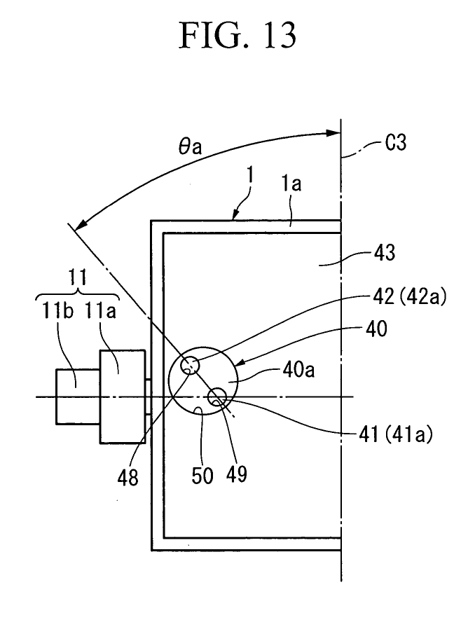

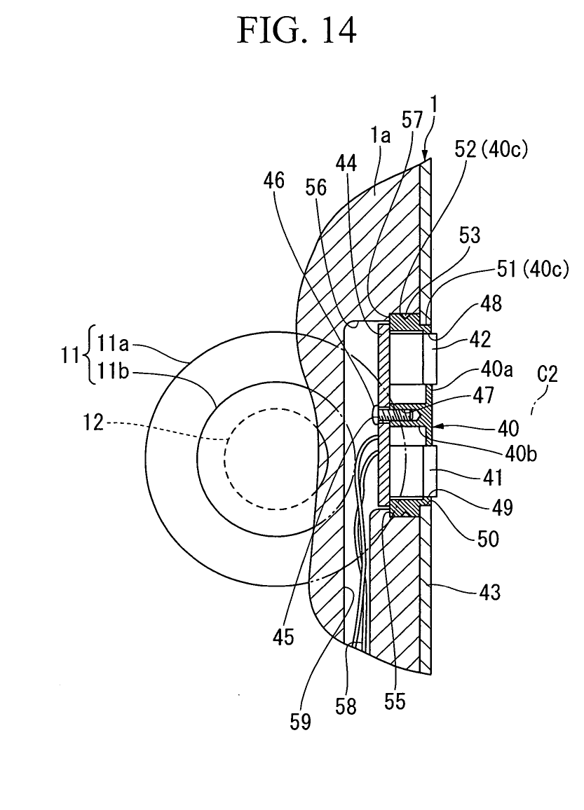

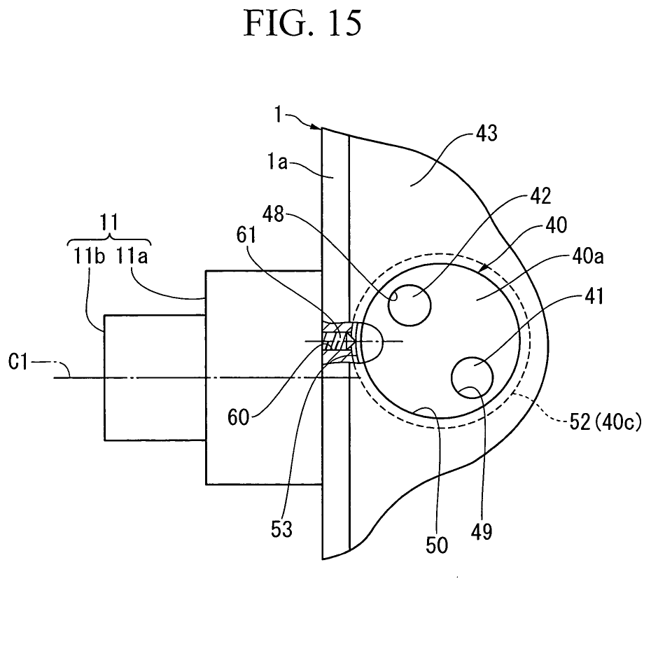

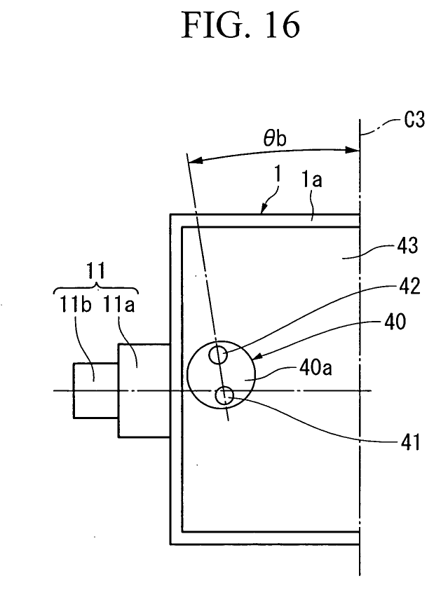

FIG. 13 is a view seen from arrow “Y” of the microscope in the embodiment of FIG. 1, and FIG. 14 and FIG. 15 show the details of the constitution thereof. FIG. 16 is a view seen from arrow “Y” of the microscope in FIG. 1. In addition, the same symbols are attached to the same constructions as the first embodiment and the second embodiment. Moreover, the explanation which duplicates with the explanations of the first embodiment and the second embodiment is omitted.

As shown in FIGS. 13 and 14, the microscope in the present embodiment has a constitution that the push switches 41 and 42 are accommodated in the rotation seat (supporting member) which can rotate with respect to the front surface panel 43 which covers the front surface of the base portion 1a. In addition, the switches 41 and 42 have the same function as the switches 25 and 26 according to the first embodiment, and have contacts 41a and 42a, respectively. Moreover, a straight line which passes through a center of the switch 41 (contact 41a) and a center of the switch 42 (contact 42a) is inclined with respect to a horizontal plane which passes through the rotation axis C1 of the focusing handles 10 and 11, and has a falling gradient from a left end portion toward a center portion in the front surface 43.

The switches 41 and 42 are fixed to a substrate 44. The substrate 44 has a disc shape, and two switches 41 and 42 are fixed on a diameter thereof. Moreover, a screw hole 45 is formed in the center of the substrate 44, and the rotation seat 40 is fixed at the screw hole 45 with a screw 46.

The rotation seat 40 has a cylindrical shape with a bottom, a standing portion 40b stands from the center of the bottom portion 40a, and the screw hole 47 in which the screw 46 is screwed is formed to the standing portion 40b. Furthermore, two holes 48 and 49 in which the switches 41 and 42 are inserted are formed at the bottom portion 40a at the position corresponding to the position of the switches 41 and 42. The outside diameter of the bottom portion 40a is almost the same as the diameter of the aperture 50 of the front panel 43. Moreover, a side surface 40c of the rotation seat 40 has a small diameter portion 51 which is connected to the bottom portion 40a, and has a diameter which is almost the same as the diameter of the aperture 50 of the front panel 43, and a large diameter portion 52 of which the outside diameter is larger than the diameter of the small diameter portion 51. A V-shape groove 53 is formed to an outside circumference of the large diameter portion 52. In addition, the outside diameter of the large diameter portion 52 is larger than the outside diameter of the substrate 44.

The base portion 1a which rotatably supports the rotation seat 40 and the substrate 44 is provided with an fitting portion 55 which is an opening of which an inner diameter is almost the same as the diameter of the large diameter portion 52 of the rotation seat 40, and an accommodation portion 56 which is an opening of which the diameter is smaller than the fitting portion 55. Furthermore, a boundary of the fitting portion 55 and the accommodation portion 56 forms a knocking portion 57 to which the rotation seat 40 knocks, and the rotation seat 40 is put between the knocking portion 57 and the front surface panel 43. Therefore, the movements of the rotation seat 40 and the substrate 44 in the direction along the rotation axis C2 are regulated by the front surface panel 43 and the knocking portion 57.

In addition, a cable hole 59 which draws around a cable 58 is formed at the lower side of the accommodation portion 56. One end of the cable 58 passes through a back surface of the substrate 44, and is connected to the contacts 41a and 42a of the switches 41 and 42. Another end of the cable 58 is connected to the electric circuit (not shown in the figures) which performs a rotation control of the revolver 5. Moreover, as shown in FIG. 15, a screw hole 60 is formed toward the V-shape groove of the rotation seat 40 at the side surface of the base portion 1. A sharp end of screw 61 is screwed into the screw hole 60.

In the state that the sharp end of screw 61 is screwed, a front end of the sharp end of screw 61 and the V-shape groove 53 are engaged with each other, and the rotation seat 40 is fixed to the base portion 1a and to the front surface panel 43. For example, in FIG. 13, a straight line which connects a center of the switch 47 and a center of the switch 48 has an inclination of a predetermined angle θa with respect to an axis line C in a perpendicular direction of the microscope body 1.

When an observation is performed by the microscope, the positions of the switches 41 and 42 can be adjusted according to the size of hand P1 of the observer P2, or the demand of the observer P2. Concretely, first, the sharp end of screw 61 is loosened by a hexagonal wrench, or the like, and the engagement between the sharp end of screw 61 and the V-shape groove of the rotation seat 40 is loosened. Furthermore, the rotation seat 40 is rotated for each switch 41 and 42 so that the switches 41 and 42 are arranged on the operating locus 24 which is formed in the case in which the observer P2 rotates the thumb P11 at the center of the CM joint P12. Furthermore, the positions of the switches 41 and 42 are adjusted, the sharp end of screw 61 is screwed at the position thereof, and the rotation seat 40 is fixed to the base portion 1a.

According to the present embodiment, by loosening the sharp end of screw 61, the rotation seat 40 can be rotated along the fitting portion 55 at the center of the rotation axis C2. For example, the rotation seat 40 is rotated from the angle θa as shown in FIG. 13 to the angle θb as shown in FIG. 16, and the rotation seat 40 is fixed by screwing the sharp end of screw 61, and thereby the arrangement of the switches 41 and 42 can be set to an unprescribed angle at the center of the rotation axis C2.

Moreover, in addition to the effect of the first embodiment, because the positions of the switches 41 and 42 can be modified according to the size of the hand P1, the length of the thumb P11, the posture of the observer P2, or the like, adaptability and operation performance are further improved.

In addition, the present invention is not limited to each embodiment as mentioned above, and wide application can be performed for the present invention.

For example, the number of the switches which are arranged for controlling the driving portion such as the revolver 5 or the diaphragm 35 may be three or more. In this case, the straight line which connects the centers of the switches adjacent to each other is arranged so that the straight line is inclined with respect to a horizontal axis of the microscope.

Moreover, in the third embodiment, the switches 27 and 28 may be arranged at the right side of the front panel 43, and the switches 27 and 28 may be corresponded to the diaphragm 35. Furthermore, the switches 27 and 28 may be attached to the rotation seat and the substrate which are the same construction as the rotation seat 40 and the substrate 44 as mentioned above, and the switches 27 and 28 may be rotated with respect to the base portion 1a (and the front panel 43).

Furthermore, the shape, the material, or the surface treatment of the switches 25 and 26 may be different from each other, and the switches 25 and 26 may be easily distinguished. Moreover, the above description is applied for the switches 27 and 28, and the switches 41 and 42 as well as the switches 25 and 26.

Moreover, the switches arranged at the front surface may be multi-contact switches such as seesaw switches or tumbler switches. This kind of switch has the composition in which both ends thereof are projected or depressed by turns, and the contact is arranged at each of both ends. Such a multi-contact switch has the function of the switches 25 and 26 with a switch, for example. In this case, a shaking axis of the multi-contact switch is arranged on the operation locus 24 and 29 of the CM joint P12 and P32 (see FIG. 8). Moreover, when the multi-contact switch is arranged near the right end of the front surface of the microscope body, the straight line which connects two contacts adjacent to each other has a falling gradient from a right end toward a center in the front surface. Similarly, when the multi-contact switch is arranged near the left end, the straight line which connects two contacts adjacent to each other has a falling gradient from a left end toward a center in the front surface.

Furthermore, the switch may be a lever-type multi-contact switch. This kind of switch is composed so that the lever moves in one axis in a straight line in both directions, and has at least two contacts along the direction in which the lever is pushed from the center of shaking. The shaking axis of the lever is arranged on the operation locus 24 and 29 of the CM joints P12 and P32. For example, the lever type of multi-contact switch is arranged near the right end of the front surface of the microscope body, the straight line which connects two contacts adjacent to each other has a falling gradient from a right end toward a center in the front surface.

Furthermore, the straight line which connects the adjacent switches or the adjacent contacts may be arranged so that the straight line has a rising gradient from the left end toward the center in the front surface panel 43. When the focusing handle 10 or 11, or each switch 25 to 28, 41, and 42 is operated in the state in which the thumbs P11 and P31 are lowered, the focusing handle or the switch can be easily operated. In such a case, the arrangement of the switches 25 to 28, 41, and 42 corresponds to the rotation direction of the revolver 5, the magnification of the objective lenses 4, or the movement of the diaphragm 35, or the like.

Moreover, the arrangement of the switches 25 and 26 which rotates the revolver 5, and of the switches 27 and 28 which adjusts an aperture diameter of the diaphragm 35 is not limited to the above-mentioned embodiment, for example, the inverted arrangement against the above-mentioned embodiment may be adopted.

Moreover, the switch according to the present invention may be composed as another unit, and may be fixed to the front surface of the microscope as back matter by adhering or fixing using the screw.

In the present microscope, two switches which are provided at the front surface of the lower portion of the microscope body are arranged inclining with respect to the rotation axis of the focusing handle. When two switches are arranged as such a way, in the case in which the switches are operated by the thumb in the state that hands are put on the focusing handle, only by moving the thumb at the center of the root joint of the thumb from the position at which one switch is pushed, the other switch can be pushed. Therefore, because the operation of the switch can be performed without hardly moving the hand from the focusing handle, a natural operation can be performed, and the operation of the switch can be surely performed.

According to the present invention, even if the number of the switches is three or more, a smooth operation can be performed by a natural finger operation. Furthermore, when the switches are arranged on a circular arc along the operation locus of the finger, the smooth operation can be performed, and the operation can be performed by the natural finger operation.

In the present invention, a driving portion is provided, the driving portion is a revolver for a objective lens, and the revolver for the objective lens is rotated in clockwise and counterclockwise directions by the switches. According to such a constitution, the revolver can be rotated by operating the switch arranged at the front surface of the lower portion of the microscope body with the thumb.

In the present microscope, when the observer faces the microscope body, in the case in which, seen from the observer, the revolver is rotated toward a right direction, the switch at the right side may be operated. Moreover, when the observer views the revolver, in the case in which the revolver is rotated toward the left direction, the switch at the left side may be operated. Thus, by matching the rotation direction of the revolver and the left and right direction of the switch, identification of the rotation direction of the revolver can be carried out. Moreover, because the arrangement of the switch in the width direction corresponds to the rotation direction of the revolver, the observer can understands the arrangement of the switch, and the operation performance is good. Therefore, operation errors can be avoided.

In the present microscope, when the magnification of the objective lens needs to be increased, the switch at the upper side may be operated, and when the magnification of the objective lens needs to be reduced, the switch at the lower side may be operated. Thus, because the raising and lowering of the magnification of the objective lens correspond to the arrangement of the switch in upward and downward, the rotation direction of the revolver can be easily discerned. Therefore, operation errors can be avoided.

In the present invention, in the case in which the switches are arranged at the right side and the left side of the front surface of the microscope body, respectively, a plurality of switches are provided at both sides of the front surface, and thereby the operation of the driving portion can be performed by either left hand or right hand. Therefore, operation errors can be avoided. Both the switch at the right side and the switch at the left side may be used as the switches for revolver, and the switch arranged at either right side or left side may be used as the switch of the driving portion except the revolver.

In the present invention, when the switch which rotates the revolver is arranged at the front surface of one side of the focusing handles, and the switch which controls the diaphragm of the light which illuminates the sample is arranged at the front surface of another side of the focusing handles, the diaphragm for the brightness of the microscope can be adjusted by operating the switch arranged at the front surface of the lower portion of the microscope body with the thumb. Especially, the brightness of the field of view when the observation by the microscope is performed can be controlled by the operation at hand.

In the present invention, when the fixing member is attached to the supporting member which is rotatable, and fixes the supporting member at an unprescribed rotation angle, not less than two switches which are arranged at the front surface of the lower portion of the microscope body are rotatably provided with respect to the front surface. Furthermore, because the switches can be fixed at a predetermined rotation angle, the observer can adjust the inclination of the straight line which connects to between the switches according to the length of the finger or the posture. Moreover, because the switches can be arranged according to the size of hand of the observer, the length of the finger, or the difference of the posture, adaptability and operation performance becomes excellent.

In the present microscope, the contacts of the switches which are provided at the front surface of the lower portion of the microscope body are arranged inclining with respect to a rotation axis of the focusing handle. When the contacts of the switches are arranged as such, in the case in which the switch are operated by the thumb in the state that hands are put on the focusing handle, by pushing one of the switches, or only by moving the thumb at the center of the root joint of the thumb from the position at which the switch is switched, the switches can be switched. In addition, when one switch has one contact, a plurality of switches are arranged while inclining. Moreover, in the case of a multi-contact switch, one switch is arranged so that a plurality of contacts are arranged while inclining. Therefore, because the operation of the switch can be performed without hardly moving the hand from the focusing handle, a natural operation can be performed, and the operation of the switch can be surely performed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A microscope comprising:
a microscope body;
a stage which is provided at the microscope body, and on which a sample is placed;
focusing handles which are provided at both sides of the microscope body to move the stage in upward and downward;
an optical system which performs an image formation of an optical image of the sample; and
a plurality of switches which are provided at a lower part of the microscope body,
wherein at least two switches which are adjacent to each other are provided at a front surface of the microscope body, and two switches thereof are inclined with respect to a rotation axis of the focusing handle.

2. A microscope according to claim 1, wherein the switches are arranged on a circular arc.

3. A microscope according to claim 1, further comprising a driving portion which is a revolver for a objective lens, the revolver for the objective lens being rotated in clockwise and counterclockwise directions by the switches.

4. A microscope according to claim 3, wherein, in the case of being seen from the front surface of the microscope body, the switch which rotates the revolver toward a right direction is arranged at a right side of the switch which rotates the revolver toward a left direction.

5. A microscope according to claim 3, wherein the switch which rotates the revolver to increase a magnification of the objective lens is arranged at an upper side of the switch which rotates the revolver to lower the magnification of the objective lens.

6. A microscope according to claim 1, wherein the switches are arranged at a right side and at a left side of the front surface of the microscope body, respectively.

7. A microscope according to claim 6, wherein the switch which rotates the revolver is arranged at the front surface of one focusing handle side, and a plurality of switches which control a diaphragm of a light which illuminates the sample are arranged at the front surface of another focusing handle side.

8. A microscope according to claim 1, further comprising a fixing member, wherein the fixing member is attached to a supporting member which is rotatable with respect to the front surface, and fixes the supporting member at an unprescribed angle.

9. A microscope comprising:
a microscope body;
a stage which is provided at the microscope body, and on which a sample is placed;
focusing handles which are provided at both sides of the microscope body to move the stage in upward and downward;
an optical system which performs an image formation of an optical image of the sample; and
a plurality of switches which are provided at a lower part of the microscope body,
wherein at least two contacts of the switches which are adjacent to each other are provided at a front surface of the microscope body, and the two contacts are inclined with respect to a rotation axis of the focusing handle.
